(19) United States
(12) Patent Application Publication
(10) Pub. No.: US 2014/0181857 A1
(43) Pub. Date: Jun. 26, 2014

(54) ELECTRONIC DEVICE AND METHOD OF CONTROLLING SMART TELEVISIONS

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); HO-I SUN, New Taipei (TW); I-CHIN HUNG, New Taipei (TW); CHUN-KAI WU, New Taipei (TW); CHIA-CHING HSU, New Taipei (TW)

(73) Assignee: HON HAI PRECISION INDUSTRY CO., LTD., New Taipei (TW)

(21) Appl. No.: 14/140,457

(22) Filed: Dec. 24, 2013

(30) Foreign Application Priority Data
Dec. 26, 2012 (TW) 101150009

(51) Int. Cl. H04N 21/41; H04N 21/414; H04N 21/4227; H04N 21/258

(52) U.S. Cl. CPC H04N 21/4126; H04N 21/25825; H04N 21/41407; H04N 21/4227
USPC 725/25

(57) ABSTRACT

In a method of controlling a smart television (TV), one or more portable electronic device are authenticated to control the smart TV. When more than one authenticated portable electronic devices send a power-on signal to the smart TV, a normal mode is executed. When only one authenticated portable electronic device sends a power-on signal to the smart TV, a personal mode can be executed. The personal mode comprises a favorite program list, which records names of one or more programs, and a favorite channel list, which records one or more channels and times of broadcasting programs of the channels. Then, the smart TV is controlled according to commands sent by the one or more authenticated portable electronic devices.

### BACKGROUND

1. Technical Field

Embodiments of the present disclosure relate to a field of device controlling technology, and more particularly, to an electronic device and a method of controlling a smart television.

2. Description of Related Art

With the development of technology, televisions have been equipped with user interfaces (UI) and operating systems (OS). This enables users to use their smart phone as a remote control to select a channel, adjust a volume, and so on. However, a method to allow individualized control of the television by different users is desired.

### BRIEF DESCRIPTION OF THE DRAWINGS

FIG. 1 is a block diagram of one embodiment of a hardware configuration of a TV control system.

FIGS. 2 and 3 are block diagrams of one embodiment of function modules of the TV control system.

FIG. 4 is a flowchart of one embodiment of a method of controlling a smart television.

FIG. 5 is a flowchart of one embodiment of details of step S01 in FIG. 4.

FIG. 6 is a flowchart of one embodiment of details of step S06 in FIG. 4.

FIG. 7 is a flowchart of one embodiment of details of step S08 in FIG. 4.

FIG. 8 is a schematic diagram of a user interface of the TV control system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processers. The modules described herein may be implemented as either software and/or hardware modules and may be stored in any type of non-transitory computer-readable storage medium or other computer storage device.

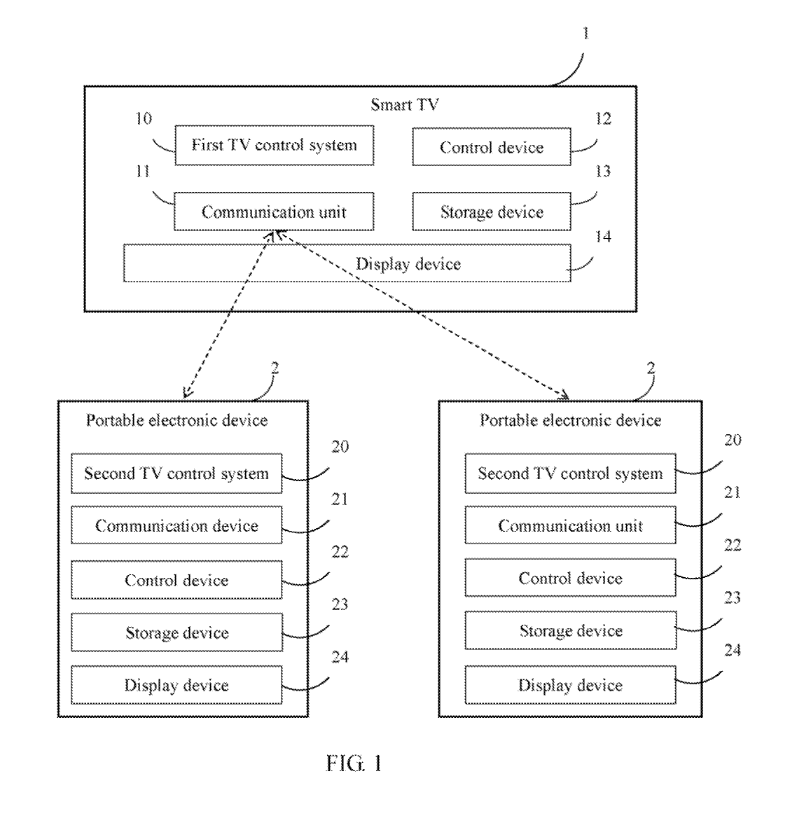

FIG. 1 is a block diagram of one embodiment of a hardware configuration of a TV control system. The TV control system comprises a smart television (hereinafter “TV”) 1 having a first TV control system 10 installed therein, and one or more portable electronic devices 2 each having a second TV control system 20 installed therein. The portable electronic device 2 can be a smart phone, a personal digital assistant (PDA), a portable computer, for example.

In one embodiment, the smart TV 1 further comprises a communication unit 11, a control device 12, a storage device 13, and a display device 14. One skilled in the art will recognize that the smart TV 1 can be configured in a number of other ways and comprise other or different components.

The communication unit 11 can be a BLUETOOTH unit, an infrared unit, a WIFI unit, or the like. The control device 12 can be a processor, a microprocessor, an application-specific integrated circuit (ASIC), a field programmable gate array (FPGA), or the like. The storage device 13 can comprise some type(s) of non-transitory computer-readable storage mediums, such as a hard disk drive, a compact disc, a digital video disc, or a tape drive. The display device 14 is a screen of the smart TV 1.

In one embodiment, each of the portable electronic devices 2 further comprises a communication unit 21, a control device 22, a storage device 23, and a display device 24. One skilled in the art will recognize that the portable electronic device 2 may be configured in a number of other ways and may comprise other or different components.

Similarly, the communication unit 21 can be a BLUETOOTH unit, an infrared unit, a WIFI unit, or the like. The control device 22 can be a processor, a microprocessor, an application-specific integrated circuit (ASIC), a field programmable gate array (FPGA), or the like. The storage device 23 can comprise some type(s) of non-transitory computer-readable storage mediums, such as a hard disk drive, a compact disc, a digital video disc, or a tape drive. The display device 24 is a screen of the portable electronic device 2.

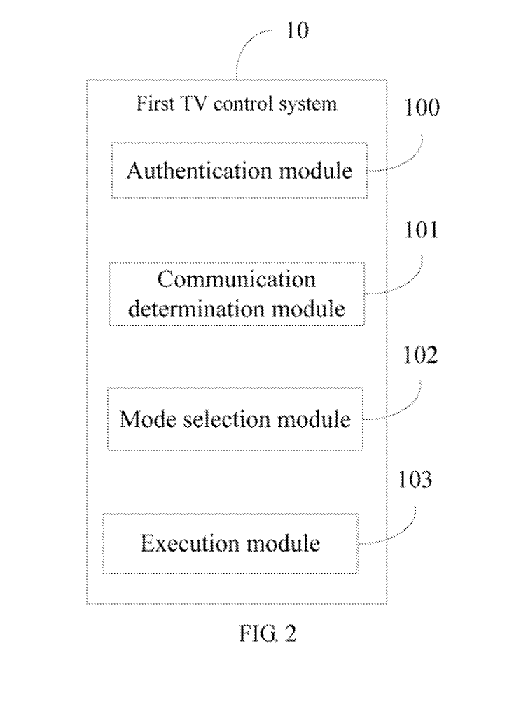

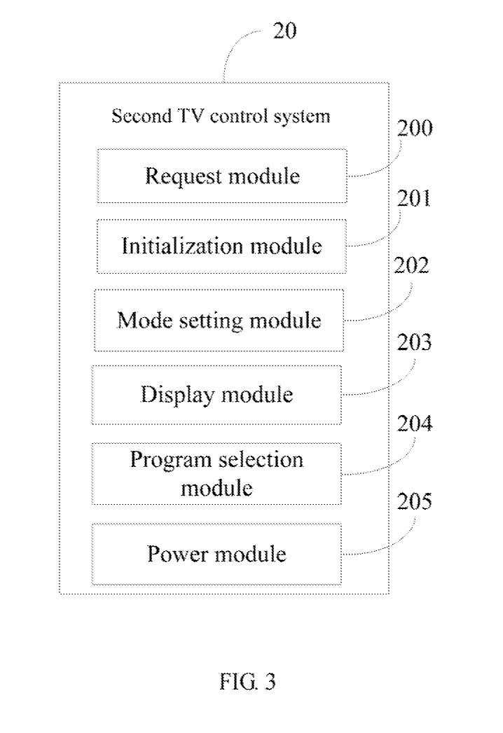

The first TV control system 10 and the second TV control system 20 comprise computerized codes in the form of one or more programs, which are stored respectively in the storage device 13 of the smart TV 1 and the storage device 23 of the portable electronic device 2. In one embodiment, the one or more programs of the first TV control system 10 and of the second TV control system 20 are described in the form of function modules (see FIGS. 2-3).

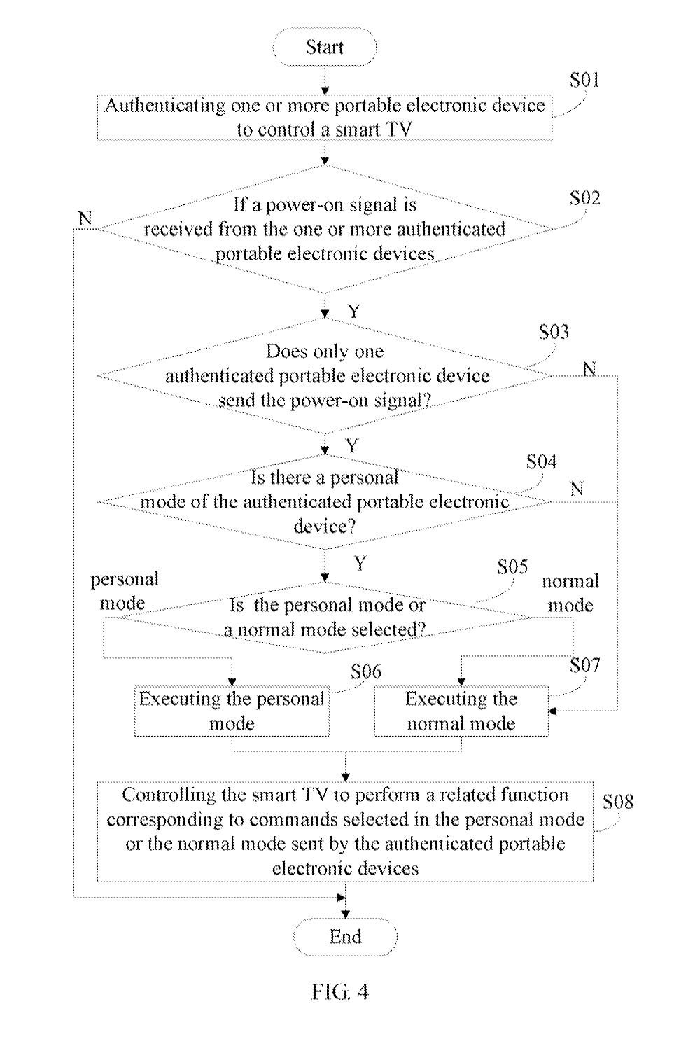

Referring to FIG. 2, the first TV control system 10 comprises an authentication module 100, a communication determination module 101, a mode selection module 102, and an execution module 103. Referring to FIG. 3, the second TV control system 20 comprises a request module 200, an initialization module 201, a mode setting module 202, a display module 203, a program selection module 204, and a power module 205. Details of the functions of the function modules 100-103 and of the function modules 200-205 are described with reference to FIGS. 4-7.

FIG. 4 is a flowchart of one embodiment of a method of controlling the smart TV 1. Depending on the embodiment, additional steps in FIG. 4 may be added, others removed, and the ordering of the steps may be changed.

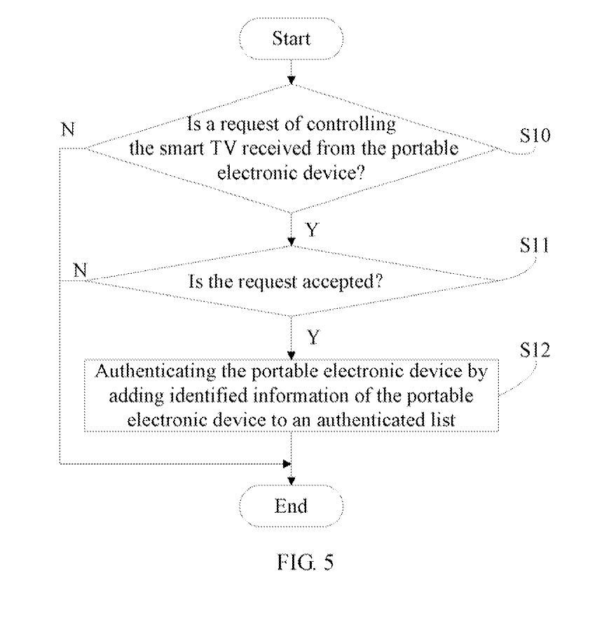

In step S01, the authentication module 100 authenticates one or more portable electronic devices 2 to control the smart TV 1. FIG. 5 below describes details of step S01.

In step S02, the communication determination module 101 determines if a power-on signal is received from the one or more authenticated portable electronic devices 2. In one embodiment, when the communication unit 11 of the smart TV 1 receives a power-on signal from a portable electronic device 2, the communication determination module 101 compares identification information of the portable electronic device 2 with identification information of the authenticated portable electronic devices 2. If the identification information of the portable electronic device 2 matches identification information of one of the authenticated portable electronic devices 2, step S03 is implemented. Otherwise, if the communication determination module 101 determines that the identification information of the portable electronic device 2 does not match any of the authenticated portable electronic devices 2, the procedure ends.

In step S03, the communication determination module 101 further determines if only one authenticated portable electronic device 2 sends the power-on signal. If only one authenticated portable electronic device 2 sends the power-on signal, step S04 is implemented. If more than one authenticated portable electronic device 2 sends the power-on signal, step S07 is implemented.

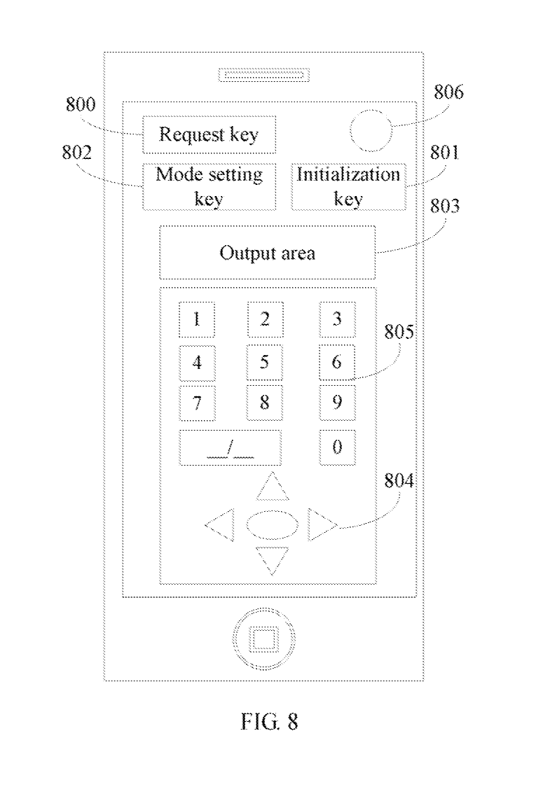

In step S04, the mode selection module 102 determines if there is a personal mode on the authenticated portable electronic device 2. The personal mode comprises individualized settings, such as a favorite program list, a favorite channel list, and/or favorite attributes. The favorite program list records names of one or more programs, such as films, teleplays, variety shows, and the like. The favorite channel list records one or more channels and times of broadcasting programs of the channels, such as channel 1 during 08:00-08:30, channel 2 during 14:00-15:00, channel 3 during 18:00-18:30, and channel 4 during 20:00-22:00. The favorite program list and the favorite channel list can be edited, added, or deleted using a mode setting key 802 in a user interface of the second TV control system 20, as illustrated in FIG. 8, shown on the display device 24 of any portable electronic device 2. The favorite attributes can record a volume, a contrast, and brightness, for example. The favorite attributes can be edited using an initialization key 801 in the user interface of the second TV control system 20, as illustrated in FIG. 8. If there is a personal mode on the authenticated portable electronic device 2, step S05 is implemented. Otherwise, if there is no personal mode, step S07 is implemented.

In step S05, the mode selection module 102 displays a mode selection list in an output area 803 (FIG. 8) of the portable electronic device 2 for a user to select the personal mode or a normal mode. If the user selects the personal mode, the procedure goes to step S06. Otherwise, if the user selects the normal mode, the procedure goes to step S07. FIG. 8 shows a user interface of the second TV control system 20 comprising the output area 803.

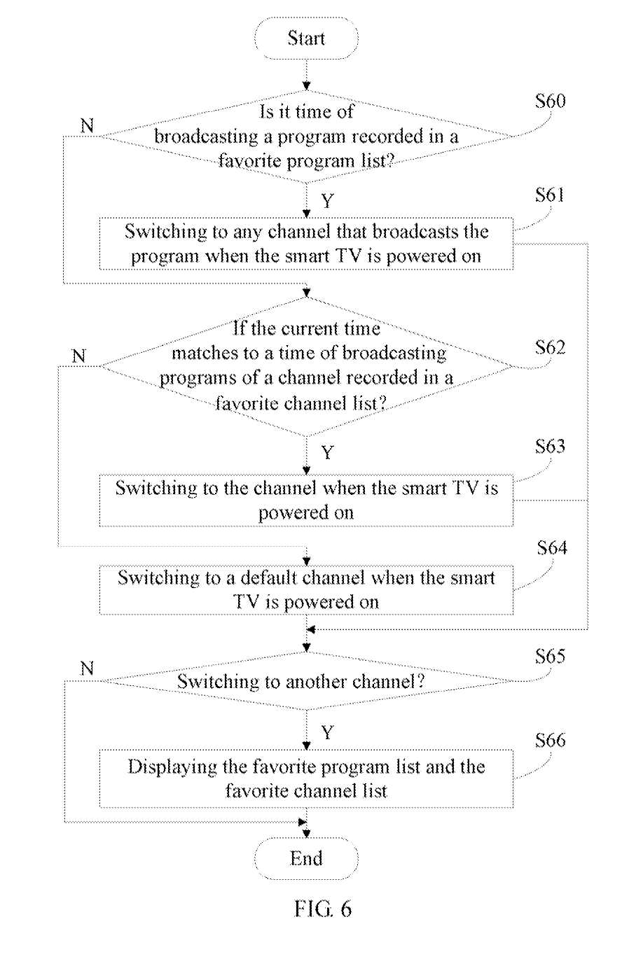

In step S06, the mode selection module 102 executes the personal mode. FIG. 6 below describes details of step S06.

In step S07, the mode selection module 102 executes the normal mode.

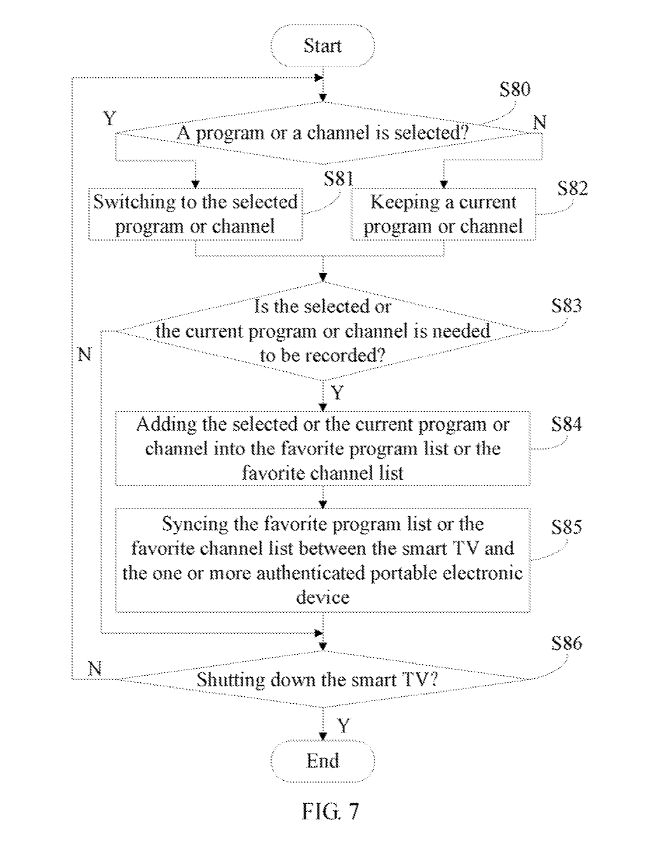

In step S08, the execution module 103 controls the smart TV 1 to perform a related function corresponding to commands selected in the personal mode or the normal mode sent by the one or more authenticated portable electronic devices 2. FIG. 7 below describes details of step S08.

FIG. 5 is a flowchart of one embodiment of details of step S01 in FIG. 4. Depending on the embodiment, additional steps in FIG. 5 may be added, others removed, and the ordering of the steps may be changed.

In step S10, the authentication module 100 determines if a request of controlling the smart TV 1 is received from a portable electronic device 2. In one embodiment, when a request key 800 in the user interface of the second TV control system 20, as illustrated in FIG. 8, is pressed, the portable electronic device 2 sends the request of controlling the smart TV 1 to the smart TV 1, when the communication unit 11 of the smart TV 1 receives the request, the authentication module 100 determines that a request of controlling the smart TV 1 is received from the portable electronic device 2, and step S11 is implemented. Otherwise, when no request is received, the procedure ends.

In step S11, the authentication module 100 determines if the request is accepted. In one embodiment, when a request of controlling the smart TV 1 is received, the user interface of the first TV control system 10 shown on the display device 14 of the smart TV 1 may show an accept option and a deny option. When a moderator/administrator of the smart TV 1 selects the accept option, the authentication module 100 determines that the request is accepted, and step S12 is implemented. Otherwise, when the moderator/administrator of the smart TV 1 selects the deny option, the authentication module 100 determines that the request is not accepted, and the procedure ends.

In step S12, the authentication module 100 authenticates the portable electronic device 2 by adding identification information of the portable electronic device 2 to an authenticated list.

FIG. 6 is a flowchart of one embodiment of details of step S06 in FIG. 4. Depending on the embodiment, additional steps in FIG. 6 may be added, others removed, and the ordering of the steps may be changed.

In step S60, the mode selection module 102 determines if it is time of broadcasting a program recorded in the favorite program list. As mentioned above, the favorite program list records names of one or more films, one or more variety shows, and the like. When one of the recorded programs in the favorite program list is currently broadcasting on any channel, the mode selection module 102 determines that it is time of broadcasting a program recorded in the favorite program list. For example, the favorite program list records a name of CCTV news. The CCTV news will be broadcasting during 19:00-19:30 every day at channel 1, channel 2, and channel 3, for example. If the current time is 19:10, the mode selection module 102 determines that it is time of broadcasting a program recorded in the favorite program list, and step S61 is implemented. Otherwise, if there is no program in the favorite program list currently broadcasting on any channel, step S62 is implemented.

In step S61, the mode selection module 102 controls the smart TV 1 to switch to any channel that is broadcasting the program when the smart TV 1 is powered on. For example, if the CCTV news is currently broadcasting on channel 1, channel 2, and channel 3, then the mode selection module 102 switches the smart TV 1 to channel 1, channel 2, or channel 3 randomly when the smart TV 1 is powered on.

In step S62, the mode selection module 102 further determines if the current time matches a time of broadcasting programs of a channel recorded in the favorite channel list. As mentioned above, the favorite channel list records one or more channels and times of broadcasting programs of the channels, such as channel 1 during 08:00-08:30, channel 2 during 14:00-15:00, channel 3 during 18:00-18:30, and channel 4 during 20:00-22:00. When the current time is within any time period in the favorite channel list, the mode selection module 102 determines that the current time matches a time of broadcasting programs of a channel recorded in the favorite channel list, and step S63 is implemented. Otherwise, if the current time does not match any time of broadcasting programs of a channel recorded in a favorite channel list, step S64 is implemented.

In step S63, the mode selection module 102 controls the smart TV 1 to switch to the corresponding channel when the smart TV 1 is powered on.

In step S64, the mode selection module 102 controls the smart TV 1 to switch to a default channel when the smart TV 1 is powered on.

In step S65, the mode selection module 102 determines whether to switch to another channel. In one embodiment, when a user presses a channel switch key 804 in the user interface of the second TV control system 20 as illustrated in FIG. 8, shown on a portable electronic device 2, the mode selection module 102 determines switching to another channel, then, step 66 is implemented. Otherwise, when the mode selection module 102 determines there is no need to switch to another channel, the procedure ends.

In step S66, the mode selection module 102 displays the favorite program list and the favorite channel list on the display device 14 of the smart TV 1 and/or the display device 24 of the one or more authenticated portable electronic device 2 for the user to switch the channel.

FIG. 7 is a flowchart of one embodiment of details of step S08 in FIG. 4. Depending on the embodiment, additional steps in FIG. 7 may be added, others removed, and the ordering of the steps may be changed.

In step S80, the execution module 103 determines if either a program or a channel is selected. In one embodiment, the program and the channel can be selected through the favorite program list and the favorite channel list or using the channel selection keys 805. Step S81 is implemented when either a program or a channel is selected. Otherwise, step S82 is implemented when neither program nor channel is selected.

In step S81, the execution module 103 controls the smart TV 1 to switch to the selected program or channel.

In step S82, the execution module 103 controls the smart TV 1 to keep a current program or channel.

In step S83, the execution module 103 determines if the selected or the current program or channel is to be recorded. In one embodiment, when the mode setting key 802 in a user interface of the second TV control system 20, as illustrated in FIG. 8, is selected, the execution module 103 determines that the selected or the current program or channel is needed to be recorded, then step S84 is implemented. When the mode setting key 802 is not selected, the execution module 103 determines that the selected or the current program or channel is not to be recorded, then step S86 is implemented.

In step S84, the execution module 103 adds the selected or the current program or channel into the favorite program list or the favorite channel list. In one embodiment, if there is no the favorite program list or the favorite channel list, the execution module 103 creates the favorite program list or the favorite channel list, and then adds the selected or the current program or channel into the favorite program list or the favorite channel list.

In step S85, the execution module 103 syncs the favorite program list or the favorite channel list between the smart TV 1 and the one or more authenticated portable electronic device 2.

In step S86, the execution module 103 determines whether to shut down the smart TV 1. When a power key 806 in a user interface of the second TV control system 20 is selected, the execution module 103 shuts down the smart TV 1, and the procedure ends. If the power key 806 is not selected, the procedure returns to step S80.

It should be emphasized that the above-described embodiments of the present disclosure, comprising any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be comprised herein within the scope of this disclosure and protected by the following claims.

What is claimed is:

1. A smart television (TV), comprising:
a storage device;
at least one processor; and
one or more modules that are stored in the storage device and executed by the at least one processor, the one or more modules comprising instructions to:
authenticate one or more portable electronic devices to control the smart TV;
control the smart TV to execute a normal mode when more than one authenticated portable electronic devices send a power-on signal to the smart TV;
control the smart TV to execute a personal mode when only one authenticated portable electronic device sends a power-on signal to the smart TV, wherein the personal mode comprises a favorite program list which records names of one or more programs and a favorite channel list which records one or more channels and times of broadcasting programs of the channels; and
control the smart TV to perform related functions corresponding to commands selected in the personal mode or the normal mode sent by the one or more authenticated portable electronic devices.

2. The TV according to claim 1, wherein when authenticating one or more portable electronic devices, the one or more modules further comprising instructions to:
receive a request of controlling the smart TV from the one or more portable electronic devices; and
authenticate the one or more portable electronic devices by adding identification information of the one or more portable electronic devices to an authenticated list.

3. The TV according to claim 1, wherein when executing the personal mode, the one or more modules further comprises instructions to:
determine whether it is time of broadcasting a program recorded in the favorite program list;
control the smart TV to switch to any channel that broadcasts the program when the smart TV is powered on when it is time of broadcasting the program;
determine whether the current time matches to a time of broadcasting programs of a channel recorded in the favorite channel list; and
control the smart TV to switch to the channel whose broadcasting time recorded in the favorite channel list matches the current time, when the smart TV is powered on.

4. The TV according to claim 3, wherein when executing the personal mode, the one or more modules further comprises instructions to:
display the favorite program list and the favorite channel list on a display device of the smart TV and/or a display device of the one or more authenticated portable electronic device when there is a need to switch to another channel.

5. The TV according to claim 1, wherein when controlling the smart TV to perform related functions, the one or more modules further comprises instructions to:
control the smart TV to switch to a program or a channel which is selected through the favorite program list and the favorite channel list or channel selection keys;
add the selected program or channel into the favorite program list or the favorite channel list when the selected program or channel is not recorded in the favorite program list or the favorite channel list; and
sync the favorite program list or the favorite channel list between the smart TV and the one or more authenticated portable electronic device.

6. The TV according to claim 1, wherein the personal mode further comprises favorite attributes that records a volume, a contract and brightness.

7. A method of controlling a smart television (TV), comprising:
authenticating one or more portable electronic devices to control the smart TV;
controlling the smart TV to execute a normal mode when more than one authenticated portable electronic devices send a power-on signal to the smart TV;
controlling the smart TV to execute a personal mode when only one authenticated portable electronic device sends a power-on signal to the smart TV, wherein the personal mode comprises a favorite program list which records names of one or more programs and a favorite channel list which records one or more channels and times of broadcasting programs of the channels; and
controlling the smart TV to perform related functions corresponding to commands sent by the one or more authenticated portable electronic devices.

8. The method according to claim 7, wherein the step of authenticating one or more portable electronic devices comprises:
receiving a request of controlling the smart TV from the one or more portable electronic device; and
authenticating the one or more portable electronic device by adding identification information of the one or more portable electronic device to an authenticated list.

9. The method according to claim 7, wherein the step of executing a personal mode comprises:
determining whether it is time of broadcasting a program recorded in the favorite program list;
controlling the smart TV to switch to any channel that broadcasts the program when the smart TV is powered on when it is time of broadcasting the program;
determining whether the current time matches to a time of broadcasting programs of a channel recorded in the favorite channel list; and
controlling the smart TV to switch to the channel whose broadcasting time recorded in the favorite channel list matches the current time, when the smart TV is powered on.

10. The method according to claim 9, wherein the step of executing the personal mode further comprises:
displaying the favorite program list and the favorite channel list on a display device of the smart TV and/or a display device of the one or more authenticated portable electronic device when there is a need to switch to another channel.

11. The method according to claim 7, wherein the step of controlling the smart TV to perform related functions comprises:
controlling the smart TV to switch to a program or a channel which is selected through the favorite program list and the favorite channel list or channel selection keys;
adding the selected program or channel into the favorite program list or the favorite channel list when the selected program or channel is not recorded in the favorite program list or the favorite channel list; and
syncing the favorite program list or the favorite channel list between the smart TV and the one or more authenticated portable electronic device.

12. The method according to claim 7, wherein the personal mode further comprises favorite attributes that records a volume, a contract and brightness.

13. A non-transitory storage medium having stored thereon instructions that, when executed by processers of a smart television (TV), causes the processers to perform a method of controlling the smart TV, wherein the method comprises:
authenticating one or more portable electronic devices to control the smart TV;
controlling the smart TV to execute a normal mode when more than one authenticated portable electronic devices send a power-on signal to the smart TV;
controlling the smart TV to execute a personal mode when only one authenticated portable electronic device sends a power-on signal to the smart TV, wherein the personal mode comprises a favorite program list which records names of one or more programs and a favorite channel list which records one or more channels and times of broadcasting programs of the channels; and
controlling the smart TV to perform related functions corresponding to commands sent by the one or more authenticated portable electronic devices.

14. The non-transitory storage medium according to claim 13, wherein the step of authenticating one or more portable electronic devices comprises:
receiving a request of controlling the smart TV from the one or more portable electronic device; and
authenticating the one or more portable electronic device by adding identification information of the one or more portable electronic device to an authenticated list.

15. The non-transitory storage medium according to claim 13, wherein the step of executing a personal mode comprises:
determining whether it is time of broadcasting a program recorded in the favorite program list;
controlling the smart TV to switch to any channel that broadcasts the program when the smart TV is powered on when it is time of broadcasting the program;
determining whether the current time matches to a time of broadcasting programs of a channel recorded in the favorite channel list; and
controlling the smart TV to switch to the channel whose broadcasting time recorded in the favorite channel list matches the current time, when the smart TV is powered on.

16. The non-transitory storage medium according to claim 15, wherein the step of executing the personal mode further comprises:
displaying the favorite program list and the favorite channel list on a display device of the smart TV and/or a display device of the one or more authenticated portable electronic device when there is a need to switch to another channel.

17. The non-transitory storage medium according to claim 13, wherein the step of controlling the smart TV to perform related functions comprises:
controlling the smart TV to switch to a program or a channel which is selected through the favorite program list and the favorite channel list or channel selection keys;
adding the selected program or channel into the favorite program list or the favorite channel list when the selected program or channel is not recorded in the favorite program list or the favorite channel list; and
syncing the favorite program list or the favorite channel list between the smart TV and the one or more authenticated portable electronic device.

18. The non-transitory storage medium according to claim 13, wherein the personal mode further comprises favorite attributes that records a volume, a contract and brightness.
